(19) United States
(12) Patent Application Publication
(10) Pub. No.: US 2008/0230337 A1
(43) Pub. Date: Sep. 25, 2008

(54) BRAKE CONTROL APPARATUS FOR VEHICLES

(75) Inventors: Keigo Kajiyama, Tokyo (JP); Tadaharu Yokota, Atsugi-shi (JP); Toshiyuki Innami, Mito-shi (JP); Toshiya Oosawa, Yokohama-shi (JP); Norihiro Saita, Atsugi-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/046,713

(22) Filed: Mar. 12, 2008

(30) Foreign Application Priority Data
Mar. 19, 2007 (JP) 2007-070056

(51) Int. Cl. B60T 13/12

(52) U.S. Cl. 188/352

(57) ABSTRACT

A brake control apparatus including a reservoir tank, a housing, a pump within the housing, a suction port formed in the housing and communicated with a suction portion of the pump, a discharge port formed in the housing and communicating a discharge portion of the pump with wheel cylinders, a suction pipe connecting the suction port and the reservoir tank, and a reservoir chamber disposed within the housing between the suction portion of the pump and the suction port. The reservoir chamber has a volume capable of reserving at least a predetermined amount of the brake fluid which is required for one-time braking at a maximum fluid pressure.

### BACKGROUND OF THE INVENTION

The present invention relates to a brake control apparatus for vehicles, and more specifically, relates to a brake control apparatus including a pump that supplies a wheel cylinder with a working fluid and a fluid pressure control valve that controls a fluid pressure in the wheel cylinder.

Japanese Patent No. 3409721 (corresponding to U.S. Pat. No. 6,913,326) discloses a brake control apparatus for vehicles which supplies a fluid pressure discharged from a pump in accordance with an acceleration of the vehicle and controls a fluid pressure in a wheel cylinder using a fluid pressure control valve. The apparatus of this conventional art conducts a brake control as follows. When the pump and the fluid pressure control valve are in a normal state, the fluid pressure that is generated in a master cylinder connected with a brake pedal is prevented from being supplied to the wheel cylinder and the fluid pressure that is produced by the pump is supplied to the wheel cylinder for each wheel. This fluid pressure control is hereinafter referred to as brake-by-wire control. On the other hand, when the pump or the fluid pressure control valve in an abnormal state, the fluid pressure generated in the master cylinder is supplied to the wheel cylinder for each of front wheels and a braking force is produced depending on a depression force that is applied to the brake pedal by a vehicle driver, as conducted in a so-called manual braking.

### SUMMARY OF THE INVENTION

In the above-described apparatus of the conventional art, the pump is connected with a reservoir tank through a pipe or a hose and there is no means for solution to occurrence of fluid leakage from the pipe or the hose. Specifically, if the fluid leakage from the pipe occurs, the pump cannot suck the brake fluid to thereby cause deteriorated discharge performance thereof or cannot supply the fluid pressure to a brake cylinder. Further, in such a case, air enters into a hydraulic circuit so that a predetermined fluid pressure cannot be generated in the brake cylinder. Under this abnormal condition, the brake-by-wire control should be shifted to the manual braking. However, in order to perform the transition to the manual braking, a device for instantaneously deciding the transition to the manual braking is necessary. Accordingly, in a case where such a decision device is not equipped, a required braking force cannot be produced during a period of the transition from the brake-by-wire control to the manual braking.

It is an object of the present invention to solve the above-described problems in the apparatus of the conventional art and to provide a brake control apparatus capable of producing a braking force during a period of transition to the manual braking without complicated construction of the apparatus, even when there occurs fluid leakage from a pipe or a tube connected with a reservoir tank.

The other objects and features of this invention will become understood from the following description with reference to the accompanying drawings.

In one aspect of the present invention, there is provided a brake control apparatus for a vehicle including wheels with wheel cylinders, the brake control apparatus comprising:

a reservoir tank that reserves a brake fluid;

a housing;

a pump disposed within the housing, the pump sucking the brake fluid in the reservoir tank and discharging the brake fluid under pressure to the wheel cylinders,

a suction port that is formed in the housing and communicated with a suction portion of the pump;

a discharge port that is formed in the housing and communicates a discharge portion of the pump with the wheel cylinders;

a suction pipe that connects the suction port and a port of the reservoir tank; and

a reservoir chamber that is disposed within the housing between the suction portion of the pump and the suction port, the reservoir chamber having a volume capable of reserving at least a predetermined amount of the brake fluid which is required for one-time braking at a maximum fluid pressure.

In a further aspect of the invention, there is provided a brake control apparatus for a vehicle including wheels with wheel cylinders, the brake control apparatus comprising:

a reservoir tank that reserves a brake fluid;

a first pump and a second pump which suck the brake fluid in the reservoir tank and discharge the brake fluid under pressure to the wheel cylinders, respectively,

a first housing that accommodates the first pump, the first housing being formed with a first suction port that is communicated with a suction portion of the first pump, and a first discharge port that is communicated with a discharge portion of the first pump,

a second housing that is formed independently of the first housing, the second housing accommodating the second pump, the second housing being formed with a second suction port that is communicated with a suction portion of the second pump, and a second discharge port that is communicated with a discharge portion of the second pump and connected to the wheel cylinders,

a suction pipe that connects the first suction port and a port of the reservoir tank;

a first reservoir chamber disposed within the first housing between the suction portion of the first pump and the first suction port; and

a second reservoir chamber disposed within the second housing between the suction portion of the second pump and the second suction port,

wherein the first and second reservoir chambers each have a volume capable of reserving at least a predetermined amount of the brake fluid which is required for one-time braking at a maximum fluid pressure, and the second reservoir chamber is connected with the second discharge port through which the brake fluid in the wheel cylinders is returned to the second reservoir chamber.

In a still further aspect of the invention, there is provided a brake control apparatus for a vehicle including wheels with wheel cylinders, the brake control apparatus comprising:

a reservoir tank that reserves a brake fluid;

a housing;

a pump disposed within the housing, the pump sucking the brake fluid in the reservoir tank and discharging the brake fluid under pressure to the wheel cylinders,

a suction port that is formed in the housing and communicated with a suction portion of the pump;

a discharge port that is formed in the housing and communicates a discharge portion of the pump with the wheel cylinders;

a suction pipe that connects the suction port and a port of the reservoir tank; and a reservoir chamber that is disposed within the housing between the suction portion of the pump and the suction port, the reservoir chamber having a volume capable of reserving at least a predetermined amount of the brake fluid which is required for one-time braking at a maximum fluid pressure,

wherein the reservoir chamber comprises a backflow preventing section that prevents a backflow of the brake fluid from the reservoir chamber to the suction port and leakage of the brake fluid to an outside of the reservoir chamber,

wherein the reservoir chamber is formed in the housing, and

wherein the housing is formed with a brake fluid passage for feeding the brake fluid, and the reservoir chamber is formed by a part of the brake fluid passage which has an increased diameter.

### BRIEF DESCRIPTION OF THE DRAWINGS

FIG. 1 is a general block diagram of a first embodiment of a brake control apparatus according to the present invention.

FIG. 2 is a diagram illustrating a hydraulic circuit in the apparatus of the first embodiment.

FIG. 3 is a schematic diagram illustrating arrangement of a first unit and a second unit of the apparatus of the first embodiment which are installed into a vehicle, when viewed in a vertical direction of the vehicle.

FIG. 4 is a perspective view of the second unit of the apparatus of the first embodiment.

FIGS. 5A and 5B are perspective views of the second unit of the apparatus of the first embodiment when viewed from different directions.

FIG. 6 is a perspective view of the first unit of the apparatus of the first embodiment.

FIG. 7 is a perspective view of the second unit of the apparatus of a second embodiment, in which a second cover is attached to the second unit.

FIG. 8 is a perspective view of the second unit of the apparatus of the second embodiment, in which the second cover is detached from the second unit.

FIG. 9 is a perspective view of the second unit of the apparatus of a third embodiment, in which a second cover is attached to the second unit.

FIG. 10 is a perspective view of the second unit of the apparatus of the third embodiment, in which the second cover is detached from the second unit.

FIG. 11 is a schematic diagram illustrating arrangement of filters which are used in the first unit and the second unit of the apparatus of a fourth embodiment.

FIG. 12 is an enlarged section of a part of the respective first and second units of the apparatus of the fourth embodiment, illustrating the concrete arrangement of the respective filters.

FIG. 13 is a schematic diagram illustrating arrangement of filters which are used in the first unit and the second unit of the apparatus of a fifth embodiment.

FIG. 14 is an enlarged section of a part of the respective first and second units of the apparatus of the fifth embodiment, illustrating the concrete arrangement of the respective filters.

FIG. 15 is a schematic diagram illustrating arrangement of filters which are used in the first unit and the second unit of the apparatus of a sixth embodiment.

FIG. 16 is an enlarged section of a part of the respective first and second units of the apparatus of the sixth embodiment, illustrating the concrete arrangement of the respective filters.

FIG. 17 is a schematic diagram illustrating arrangement of the first unit and the second unit of the apparatus of a seventh embodiment which are installed into a vehicle, when viewed in a vertical direction of the vehicle.

FIG. 18 is a perspective view of the second unit of the apparatus of the seventh embodiment.

FIG. 19 is a diagram illustrating a hydraulic circuit in the apparatus of an eighth embodiment.

FIG. 20 is a schematic diagram illustrating arrangement of the second unit of the apparatus of the eighth embodiment which is installed into a vehicle, when viewed in a vertical direction of the vehicle.

### DETAILED DESCRIPTION OF THE INVENTION

First through eighth embodiments of a vehicular brake control apparatus according to the present invention, will be explained hereinafter with reference to the accompanying drawings.

[Brake-by-Wire System Configuration]

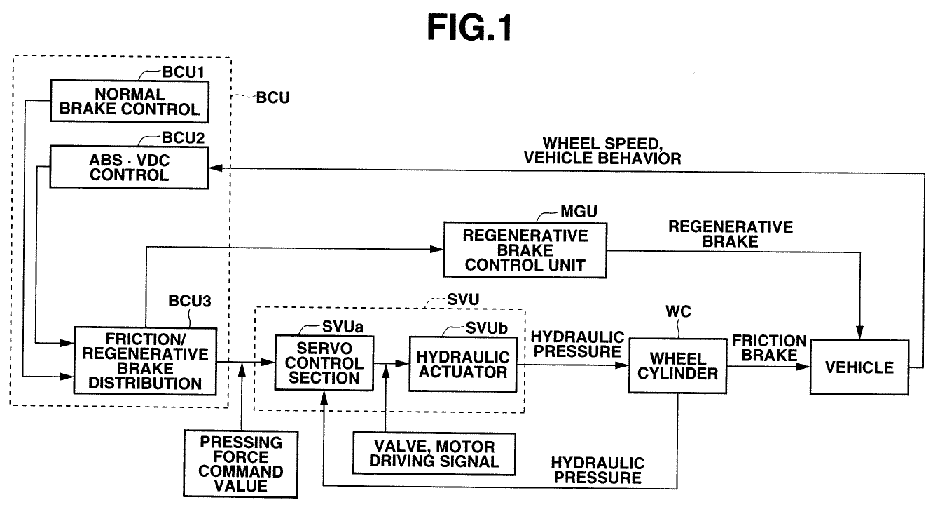

FIG. 1 is a general block diagram of a hydraulic brake-by-wire system to which the vehicular brake control apparatus of the first through eighth embodiments is applicable.

Brake control unit BCU performs computation of a normal brake control that is conducted in response to a vehicle driver's brake operation, and computation of a tire slip control and a vehicle behavior control, such as an antiskid brake system control (ABS), a vehicle behavior or stability control or vehicle dynamics control (VDC), a vehicle distance control and an obstruction avoidance control by using vehicle information, and calculates a braking force required of the vehicle.

The system further includes regenerative brake control unit MGU. In order to utilize function of regeneration to a maximum extent, regenerative brake control unit MGU distributes the calculated braking force between a regenerative brake and a hydraulically operated friction brake. Regenerative brake control unit MGU further calculates a pressing force command value for each wheel on the basis of the friction brake. Here, the regenerative brake means to produce regenerative torque upon braking by a motor/generator that is provided on a power train of a driving wheel, and recover electric power.

Next, the normal brake control is explained. At the normal brake control, a target deceleration is calculated on the basis of a brake pedal stroke amount, i.e., a driver's brake pedal operating amount, and a master cylinder pressure, i.e., a driver's brake pedal depressing force. Further, the target deceleration is achieved by distributing the braking force capable of achieving the target deceleration, between the braking force (the pressing force command value) which is generated by a hydraulic actuator and the regenerative braking force which is generated by the motor/generator.

The system further includes servo unit SVU which includes servo control section SVUa and hydraulic actuator SVUb. Servo control section SVUa performs computation of driving signals for a motor and a control valve of hydraulic actuator SVUb such that the pressing force for each wheel which is generated by a hydraulic pressure in a wheel cylinder is conformed with the pressing force command value. Servo control section SVUa then converts the driving signals to electric signals and drives hydraulic actuator SVUb.

[Hydraulic Circuit Configuration]

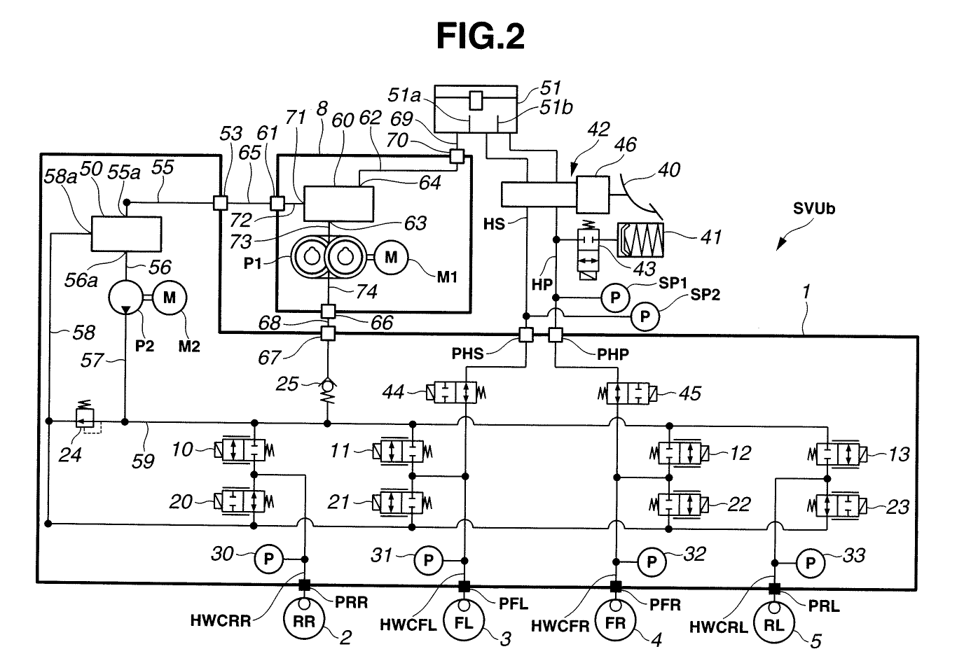

FIG. 2 shows configuration of a hydraulic circuit of the brake control apparatus of the first embodiment. Hydraulic actuator SVUb includes first unit 8, second unit 1 and a plurality of pipes which are disposed between first unit 8 and second unit 1 and supply and discharge a brake fluid therethrough. The configuration will be explained below in detail.

[Hydraulic Circuit Configuration in Hydraulic Actuator SVUb]

Prior to detailed explanation about the pipes connected to second unit 1 of hydraulic actuator SVUb, the configuration except for the pipes is explained with reference to FIG. 2.

(Connecting Relation to Master Cylinder)

As shown in FIG. 2, P-line pipe HP and S-line pipe HS which are connected to second unit 1, extend from master cylinder 42. Master cylinder 42 produces hydraulic pressure by the driver's operation of brake pedal 40. Master cylinder 42 may be a tandem type master cylinder. P-line pipe HP is connected to wheel cylinder 4 for right front wheel FR. S-line pipe HS is connected to wheel cylinder 3 for left front wheel FL.

Master cylinder 42 is provided with stroke sensor 46 which detects the driver's brake pedal operating amount and outputs a signal indicative of the driver's brake pedal operating amount. The signal from stroke sensor 46 is input to brake control unit BCU shown in FIG. 1.

Stroke simulator 41 is connected to P-line pipe HP via normally-closed cancel valve 43. Under the brake-by-wire control, cancel valve 43 is opened to supply the brake fluid in a P-line side portion of master cylinder 42 to stroke simulator 41, whereby the brake pedal stroke is ensured. Reservoir tank 51 that reserves the brake fluid is connected with master cylinder 42 and communicated with P-line pipe HP and S-line pipe HS.

Two partition walls 51a, 51b are disposed within reservoir tank 51 and divide an interior space of reservoir tank 51 into three chambers. Partition walls 51a, 51b extend from a bottom surface of reservoir tank 51 to a predetermined height in a vertical direction of reservoir tank 51. One of the three chambers is connected with P-line pipe HP and another of the three chambers is connected with S-line pipe HS. The remaining chamber is connected with suction pipe 69 that is connected to first unit 8. Owing to this configuration, even when leakage of the brake fluid occurs in one of P-line pipe HP and S-line pipe HS, reservoir tank 51 can reserve a predetermined amount of the brake fluid which is fed to the other of P-line pipe HP and S-line pipe HS in accordance with the height of partition walls 51a, 51b.

(Connecting Relation to First Unit)

High pressure pipe 68 that is connected with a discharge side of first pump P1 of first unit 8, is connected to second unit 1. Further, low pressure pipe 65 that is connected with first reservoir chamber 60 within first unit 8, is connected to second unit 1.

(Configuration of Various Circuits in Second Unit)

Second unit 1 includes second motor M2 and second pump P2 that is driven by second motor M2. Second motor M2 is a brush motor that is available at a low cost. Second unit 1 further includes second reservoir chamber 50 that is connected with a suction portion of second pump P2 via hydraulic passage 56. Second reservoir chamber 50 has a volume capable of reserving a brake fluid required for at least one-time braking at a predetermined maximum fluid pressure.

Pressure increasing hydraulic passage 59 is connected with a discharge portion of second pump P2 via hydraulic passage 57. On the other hand, pressure reducing hydraulic passage 58 is connected to the suction portion of second pump P2 via second reservoir chamber 50.

Pressure increasing valve 13 and pressure reducing valve 23 are provided corresponding to wheel cylinder 5 and disposed in a hydraulic passage that extends between pressure increasing hydraulic passage 59 and pressure reducing hydraulic passage 58. Wheel cylinder-side pipe HWCRL connected to wheel cylinder 5 is connected with the hydraulic passage between pressure increasing valve 13 and pressure reducing valve 23. Similarly, pressure increasing valve 12 and pressure reducing valve 22 are provided corresponding to wheel cylinder 4 and disposed in a hydraulic passage that extends between pressure increasing hydraulic passage 59 and pressure reducing hydraulic passage 58. Wheel cylinder-side pipe HWCFR connected to wheel cylinder 4 is connected with the hydraulic passage between pressure increasing valve 12 and pressure reducing valve 22. Pressure increasing valve 11 and pressure reducing valve 21 are provided corresponding to wheel cylinder 3 and disposed in a hydraulic passage that extends between pressure increasing hydraulic passage 59 and pressure reducing hydraulic passage 58. Wheel cylinder-side pipe HWCFL connected to wheel cylinder 3 is connected with the hydraulic passage between pressure increasing valve 11 and pressure reducing valve 21. Pressure increasing valve 10 and pressure reducing valve 20 are provided corresponding to wheel cylinder 2 and disposed in a hydraulic passage that extends between pressure increasing hydraulic passage 59 and pressure reducing hydraulic passage 58. Wheel cylinder-side pipe HWCRR connected to wheel cylinder 2 is connected with the hydraulic passage between pressure increasing valve 10 and pressure reducing valve 20.

P-line pipe HP is connected with wheel cylinder-side pipes HWCFL via first cutoff valve 45 of a normally open type. S-line pipe HS is connected with wheel cylinder-side pipe HWCFR via second cutoff valve 44 of a normally open type.

High pressure pipe 68 is connected with pressure increasing hydraulic passage 59 via check valve 25 that allows only a flow of brake fluid toward a side of the wheel cylinders. Low pressure pipe 65 is connected with pressure reducing hydraulic passage 58 via second reservoir chamber 50. Relief valve 24 is disposed in a hydraulic passage that extends between pressure increasing hydraulic passage 59 and pressure reducing hydraulic passage 58. Relief valve 24 is operative to avoid excessive increase in the hydraulic pressure in pressure increasing hydraulic passage 59.

First master cylinder pressure sensor SP1 is disposed on P-line pipe HP on a side of the master cylinder upstream of first cutoff valve 45. Second master cylinder pressure sensor SP2 is disposed on S-line pipe HS on a side of the master cylinder upstream of second cutoff valve 44. Signals from first master cylinder pressure sensor SP1 and second master cylinder pressure sensor SP2 are input to brake control unit BCU.

Wheel cylinder hydraulic pressure sensors 30, 31, 32, 33 are disposed on wheel cylinder-side pipes HWCRL, HWCFR, HWCFL, HWCRR, respectively. Wheel cylinder fluid pressure sensors 30, 31, 32, 33 are operative to detect the respective hydraulic pressures in wheel cylinders 2, 3, 4, 5, respectively.

Second unit 1 includes P-line port PHP that is connected with P-line pipe HP and S-line port PHS that is connected with S-line pipe HS. Second unit 1 further includes second high pressure port 67 to which high pressure pipe 68 is connected, second low pressure port 53 to which low pressure pipe 65 is connected, and wheel cylinder-side ports PRL, PFR, PFL, PRR to which wheel cylinder-side pipes HWCRL, HWCFR, HWCFL, HWCRR are respectively connected.

Second reservoir chamber 50 has second inflow port 55a that is communicated with second low pressure port 53 via hydraulic passage 55. Second reservoir chamber 50 further has second outflow port 56a that is communicated with the suction portion of second pump P2 via hydraulic passage 56. Second reservoir chamber 50 further has second circulation port 58a that is connected with pressure reducing hydraulic passage 58.

(Configuration of First Unit)

First unit 8 includes first reservoir chamber 60, first motor M1 and first pump P1 that is driven by first motor M1. First reservoir chamber 60 has a volume capable of reserving at least a predetermined amount of brake fluid which is required for one-time braking at a maximum fluid pressure. First motor M1 may be a brushless motor with a rotation angle sensor, not shown, which performs drive control with high accuracy. First pump P1 may be a gear pump which has a smooth pressure rise characteristic that allows remarkably reduced pulsing as compared to a plunger pump, and performs a flow control with high accuracy. First unit 8 controls the rotation of first motor M1 in accordance with a drive command signal for first motor M1 which is transmitted from brake control unit BCU.

First unit 8 is provided with first suction port 70, first low pressure port 61 and first high pressure port 66. First suction port 70 is connected with a port of reservoir tank 51 via suction pipe 69. First low pressure port 61 is communicated with first reservoir chamber 60 and is connected to low pressure pipe 65. First high pressure port 66 is communicated with a discharge portion of first pump P1, and is connected to high pressure pipe 68.

First reservoir chamber 60 has first circulation port 71 that is communicated with first low pressure port 61 via hydraulic passage 72. First circulation port 71 is open into first reservoir chamber 60 and serves as an inflow port that permits the brake fluid in wheel cylinders 2, 3, 4, 5 to be returned to first reservoir chamber 60 as explained later. First reservoir chamber 60 further has first outflow port 63 that is communicated with a suction portion of first pump P1 via hydraulic passage 73. First reservoir chamber 60 further has first inflow port 64 that is communicated with first suction port 70 via hydraulic passage 62.

[Positional Relationship Between Ports of Respective Units and Positional Relationship Between Ports of Respective Units and Ports of Respective Reservoir Chambers]

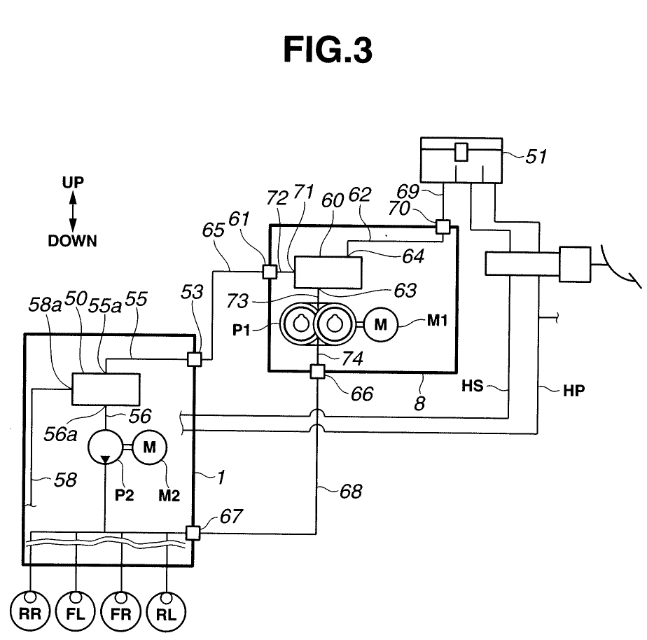

Referring to FIG. 3, there is shown a positional relationship between the ports of first and second units 8 and 1 and a positional relationship between the ports of first and second units 8 and 1 and the ports of first and second reservoir chambers 60 and 50. FIG. 3 is a schematic diagram that illustrates the ports of first and second units 8 and 1 when first and second units 8 and 1 are mounted to a vehicle, and viewed in a vertical direction of the vehicle.

[Second Unit]

When the position of second outflow port 56a is used as a reference in the vertical direction of the vehicle, second circulation port 58a is positioned upward of second outflow port 56a. Second inflow port 55a is positioned upward of second circulation port 58a. Second low pressure port 53 is positioned upward of second inflow port 55a.

[First Unit]

When the position of first outflow port 63 is used as a reference in the vertical direction of the vehicle, first outflow port 63, first circulation port 71, first inflow port 64 and first suction port 70 are successively arranged upwardly from below in the vertical direction of the vehicle. That is, first circulation port 71 is positioned upward of first outflow port 63. First inflow port 64 is positioned upward of first circulation port 71. First suction port 70 is positioned upward of first inflow port 64. First suction port 70 also is positioned upward of first low pressure port 61.

[Relationship Between First Unit and Second Unit]

First low pressure port 61 of first unit 8 is positioned upward of second low pressure port 53 of second unit 1. Specifically, low pressure pipe 65 has one end that is connected to first low pressure port 61 and the other end that is connected to second low pressure port 53. Low pressure pipe 65 downwardly extends from first low pressure port 61 to second low pressure port 53. First suction port 70 of first unit 8 which is positioned upward of first low pressure port 61, therefore, is positioned upward of second low pressure port 53.

Upon increasing the fluid pressure under the normal brake-by-wire control, the brake fluid is supplied from reservoir tank 51 to first pump P1 via first suction port 70, hydraulic passage 62, first inflow port 64, first reservoir chamber 60, first outflow port 63 and hydraulic passage 73. The brake fluid pressurized by first pump P1 is fed to second high pressure port 67 via hydraulic passage 74, first high pressure port 66 and high pressure pipe 68, and then suitably supplied to wheel cylinders 2, 3, 4, 5 via pressure increasing hydraulic passage 59.

When first unit 8 is not used as a fluid pressure source, the brake fluid is supplied from second reservoir chamber 50 to second pump P2 via hydraulic passage 56. The brake fluid pressurized by second pump P2 is suitably supplied to wheel cylinders 2, 3, 4, 5 via hydraulic passage 57 and pressure increasing hydraulic passage 59.

Upon reducing the fluid pressure in wheel cylinders 2, 3, 4, 5, the brake fluid in wheel cylinders 2, 3, 4, 5 is circulated to reservoir tank 51 as follows. First, the brake fluid in wheel cylinders 2, 3, 4, 5 is returned to second reservoir chamber 50 via pressure reducing hydraulic passage 58 and second circulation port 58a. The brake fluid is then transmitted from second reservoir chamber 50 to first low pressure port 61 through second inflow port 55a, hydraulic passage 55, second low pressure port 53 and low pressure pipe 65. The brake fluid is further transmitted from first low pressure port 61 to first suction port 70 through hydraulic passage 72, first circulation port 71, first reservoir chamber 60, first inflow port 64 and hydraulic passage 62. Finally, the brake fluid is fed from first suction port 70 to reservoir tank 51 via suction pipe 69. If the fluid pressure in pressure increasing hydraulic passage 59 within second unit 1 becomes excessively high, the brake fluid in pressure increasing hydraulic passage 59 is released into pressure reducing hydraulic passage 58 through relief valve 24. The brake fluid released is returned to reservoir tank 51 by the same route as upon reducing the fluid pressure in wheel cylinders 2, 3, 4, 5.

[Function at Occurrence of Defect]

### (When Suction Pipe is Fallen Off)

When suction pipe 69 is fallen off from reservoir tank 51 and/or first suction port 70, the brake fluid cannot be supplied from reservoir tank 51. However, since first suction port 70 is positioned upward of first inflow port 64, the brake fluid in first reservoir chamber 60 can be prevented from leaking outside first unit 8. As a result, it is possible to retain an amount of the brake fluid corresponding to the volume of first reservoir chamber 60.

First reservoir chamber 60 has the volume capable of reserving at least a predetermined amount of the brake fluid which is required for one-time braking at the maximum fluid pressure. Therefore, when transition from the brake-by-wire control to the normal manual braking is conducted upon the occurrence of the defects as described above, it is possible to avoid such a problem that a necessary amount of the brake fluid cannot be retained.

Further, first inflow port 64 is positioned upward of first outflow port 63. With this arrangement, suction ability of first pump P1 can be enhanced. In addition, even when air bubbles enter into first reservoir chamber 60 and hydraulic passage 62, first pump P1 can be substantially prevented from sucking the air bubbles to thereby suppress deterioration in discharge performance of first pump P1.

Further, second reservoir chamber 50 has the volume capable of reserving at least a predetermined amount of the brake fluid which is required for one-time braking at the maximum fluid pressure. Further, second low pressure port 53 is positioned downward of first low pressure port 61. With the construction of second reservoir chamber 50 and the arrangement of second low pressure port 53 and first low pressure port 61, even when first reservoir chamber 60 becomes empty of brake fluid, the brake fluid within second reservoir chamber 50 can be kept retained. Accordingly, even when all amount of the brake fluid within first reservoir chamber 60 runs out, the brake fluid can be continuously supplied by second pump P2 by carrying out the changeover to the control using second pump P2.

Further, second inflow port 55a is positioned upward of second outflow port 56a. With this arrangement, suction ability of second pump P2 can be enhanced. In addition, even when air bubbles enter into second reservoir chamber 50 and hydraulic passage 55, second pump P2 can be substantially prevented from sucking the air bubbles to thereby suppress deterioration in discharge performance of second pump P2.

In a case where suction pipe 69 is fallen off from reservoir tank 51 and/or first suction port 70, the brake fluid within the chamber defined by partition wall 51a and one side wall of reservoir tank 51 therebetween is drained. However, in this case, the brake fluid within the chamber defined by partition walls 51a and 51b therebetween and the brake fluid within the chamber defined by partition wall 51b and an opposite side wall of reservoir tank 51 therebetween are retained. Accordingly, there occurs no problem upon operating the manual braking.

(When Low Pressure Pipe is Fallen Off)

When low pressure pipe 65 is fallen off from first low pressure port 61 of first unit 8, the brake fluid within reservoir tank 51 flows into first low pressure port 61 through hydraulic passage 62, first inflow port 64, first reservoir chamber 60, first circulation port 71 and hydraulic passage 72. First circulation port 71 is positioned at an upper portion of first reservoir chamber 60 in the vertical direction of the vehicle as explained later. With this arrangement, the brake fluid within first reservoir chamber 60 can be prevented from leaking from first low pressure port 61 to an outside of first unit 8 through first circulation port 71. Accordingly, it is possible to retain the amount of the brake fluid which corresponds to the volume of first reservoir chamber 60.

When low pressure pipe 65 is fallen off from second low pressure port 53 of second unit 1, the brake fluid within second reservoir chamber 50 can be prevented from leaking from second low pressure port 53 to an outside of second unit 1. This is because second low pressure port 53 is positioned upward of second inflow port 55a. Accordingly, it is possible to retain the amount of the brake fluid which corresponds to the volume of second reservoir chamber 50.

Even in a case where low pressure pipe 65 is fallen off as described above, there occurs no problem upon operating the manual braking.

[Specific Constructions of First Unit and Second Unit]

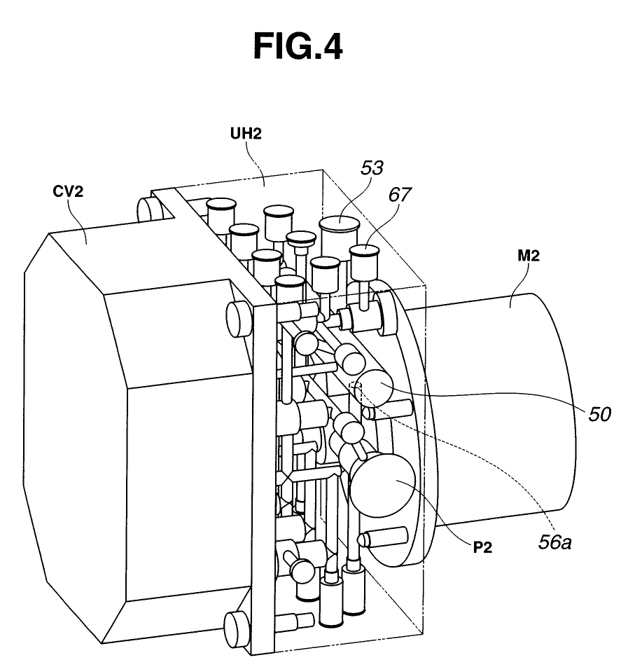

Referring to FIG. 4 through FIG. 6, specific constructions of first unit and second unit will be explained hereinafter. FIG. 4 is a perspective view of second unit 1. As illustrated in FIG. 4, second unit 1 includes second cover CV2, unit housing UH2 and second motor M2. Second cover CV2 encloses a built-in control substrate and serves as a cover for protecting various solenoid-operated valves and hydraulic sensors. Unit housing UH2 is made of an aluminum material and formed into a generally four-sided regular prism-shaped block. Second cover CV2 is disposed on one end surface of unit housing UH2 and made of a resin material. Second motor M2 is disposed on an opposite end surface of unit housing UH2.

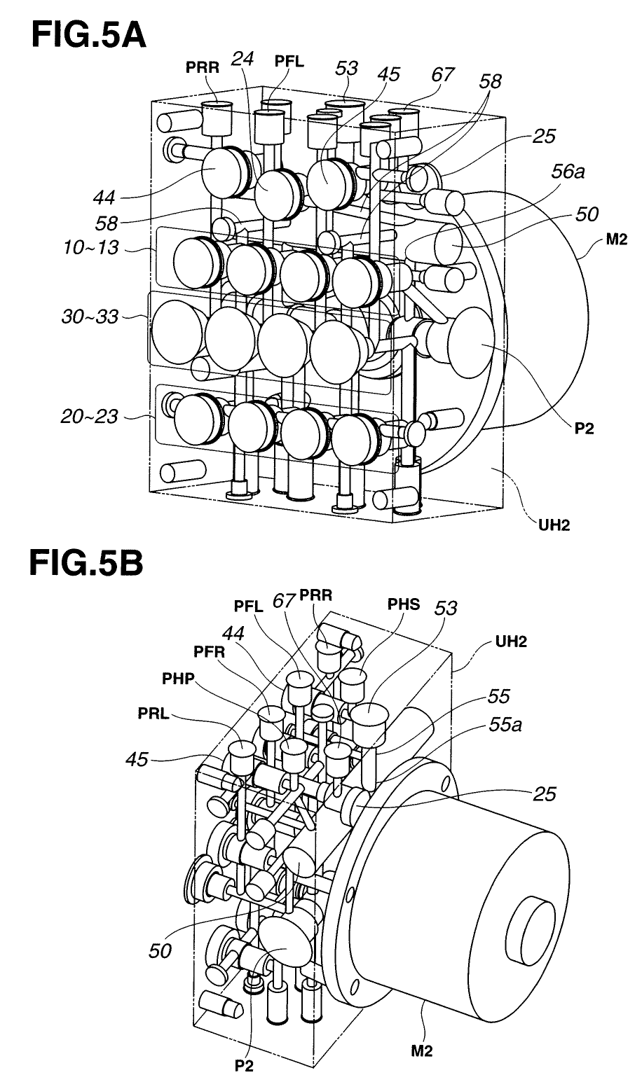

FIG. 5A and FIG. 5B are perspective views of second unit 1 when viewed in directions different from each other. FIG. 5A and FIG. 5B show arrangement of parts of second unit 1 that is installed to the vehicle, when viewed in a vertical direction of the vehicle, namely, in an up-and-down direction of the vehicle. As shown in FIG. 5A, solenoid-operated valves 10-13, 20-23, 24, 44, 45 and hydraulic sensors 30-33 are fixed to the one end surface of unit housing UH2 by a suitable fastening manner such as caulking. Second motor M2 is mounted to the opposite end surface of unit housing UH2. Unit housing UH2 includes a plurality of hydraulic passages which are formed by a suitable manner such as drilling.

As shown in FIG. 5A and FIG. 5B, a plurality of ports are formed on a top surface of unit housing UH2. The ports include second low pressure port 53 and second high pressure port 67 which are located closest to the opposite end surface of unit housing UH2. The ports also include P-line port PHP and S-line port PHS which are located apart from second low pressure port 53 and second high pressure port 67 in a direction toward the one end surface of unit housing UH2. The ports also include wheel cylinder-side ports PRR, PFL, PFR, PRL which are located apart from P-line port PHP and S-line port PHS in the direction toward the one end surface of unit housing UH2.

As shown in FIG. 5A, on the one end surface of unit housing UH2, there are provided first and second cutoff valves 45 and 44, relief valve 24, four pressure increasing valves 10-13, four hydraulic sensors 30-33, and four pressure reducing valves 20-23 which are successively arranged downwardly from above in a vertical direction of unit housing UH2, namely, in the vertical direction of the vehicle. Pressure increasing valves 10-13 are aligned in a row in a lateral direction of unit housing UH2 which extends perpendicular to the vertical direction. Hydraulic sensors 30-33 are aligned in a row in the lateral direction of unit housing UH2. Pressure reducing valves 20-23 are aligned in a row in the lateral direction of unit housing UH2. Relief valve 24 is disposed between cutoff valves 45 and 44 in the lateral direction of unit housing UH2.

As shown in FIG. 5A and FIG. 5B, second reservoir chamber 50 extends in unit housing UH2 in the lateral direction of unit housing UH2. Second reservoir chamber 50 has one end opened to one of opposite side surfaces of unit housing UH2 which are opposed to each other in the lateral direction of unit housing UH2. Second reservoir chamber 50 is communicated with hydraulic passage 58. Second reservoir chamber 50 is positioned at a height that is lower than relief valve 24 and higher than pressure increasing valves 10-13 in the vertical direction of the vehicle. Second pump P2 that is a plunger-operated pump extends in the lateral direction of unit housing UH2 and is driven by second motor M2. Second pump P2 is positioned at a height lower than pressure increasing valves 10-13 in the vertical direction of the vehicle. Hydraulic sensors 30-33 are positioned at substantially the same height as second pump P2 in the vertical direction of the vehicle. Pressure increasing valves 10-13 are positioned at a height higher than second pump P2 in the vertical direction of the vehicle, and pressure reducing valves 20-23 are positioned at a height lower than second pump P2 in the vertical direction of the vehicle.

Specifically, second reservoir chamber 50 is formed by a large-diameter hydraulic passage that extends in the lateral direction of unit housing UH2 and has an increased diameter as compared to other hydraulic passages. Second reservoir chamber 50 is formed as a space forming portion that forms a space having the above-described volume of second reservoir chamber 50. As shown in FIG. 5A and FIG. 5B, second reservoir chamber 50 is positioned upward of the suction portion of second pump P2. As shown in FIG. 5B, second inflow port 55a is provided at an upper portion of second reservoir chamber 50, and second low pressure port 53 is positioned upward of second inflow port 55a.

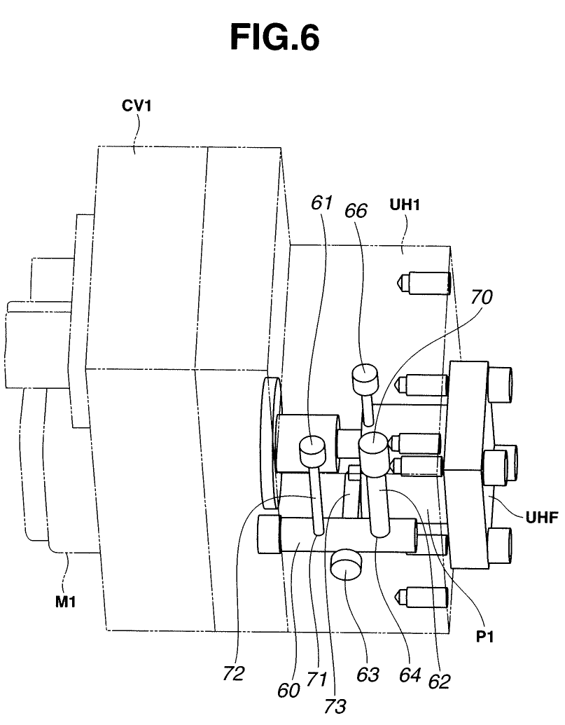

FIG. 6 is a perspective view of first unit 8. FIG. 6 shows arrangement of parts of first unit 8 that is installed to the vehicle, when viewed in a vertical direction of the vehicle. As shown in FIG. 6, first unit 8 includes unit housing UH1, first motor M1, first cover CV1 and lid UHF. Unit housing UH1 is made of an aluminum material and formed into a generally four-sided regular prism-shaped block. First motor M1 and first cover CV1 are mounted to one end surface of unit housing UH1. First cover CV1 encloses a motor control substrate, communication line and a connection port for a power supply line. Lid UHF is mounted to an opposite end surface of unit housing UH1 and accommodates first pump P1 therein. Unit housing UH1 includes a plurality of hydraulic passages which are formed by a suitable manner such as drilling.

As shown in FIG. 6, a plurality of ports are formed on a top surface of unit housing UH1. First suction port 70, first high pressure port 66 and first low pressure port 61 are successively arranged from a side of Lid UHF in a direction of a driving shaft of first pump P1.

First reservoir chamber 60 is formed by a large-diameter hydraulic passage that extends in unit housing UH1 in the direction of the driving shaft of first pump P1 and has an increased diameter as compared to other hydraulic passages. First reservoir chamber 60 is formed as a space forming portion that forms a space having the above-described volume of first reservoir chamber 60. First inflow port 64 and first circulation port 71 are formed at an upper end of the space forming portion for providing the above-described volume of first reservoir chamber 60 in the vertical direction of the vehicle. First outflow port 63 is formed at a lower end of the space forming portion for providing the above-described volume of first reservoir chamber 60 in the vertical direction of the vehicle. That is, first inflow port 64 and first circulation port 71 are open into an upper-most portion of an inner circumferential surface of first reservoir chamber 60 in the vertical direction of the vehicle, and first outflow port 63 is open into a lower-most portion of the inner circumferential surface of first reservoir chamber 60 in the vertical direction of the vehicle. First outflow port 63 is connected with the suction portion of first pump P1 via hydraulic passage 73.

First reservoir chamber 60 is positioned upward of the suction portion of first pump P1 in the vertical direction of the vehicle. First inflow port 64 and first circulation port 71 are positioned upward of first outflow port 63 in the vertical direction of the vehicle.

When first unit 8 and second unit 1 are mounted to the vehicle and second outflow port 56a is used as the reference in the vertical direction of the vehicle and second reservoir chamber 50, second low pressure port 53 and first low pressure port 61 (or first suction port 70) are successively arranged upwardly from below in the vertical direction of the vehicle. With this arrangement, the brake fluid can be substantially reserved within first and second reservoir chambers 60, 50.

The above-described first embodiment of the present invention can perform the following functions and effects.

(1) The brake control apparatus of the first embodiment includes a housing, reservoir tank 51 that reserves brake fluid, and a pump that sucks the brake fluid reserved in reservoir tank 51 and discharges the brake fluid under pressure to all of wheel cylinders 2, 3, 4, 5. The housing includes unit housing UH1 for first unit 8 and unit housing UH2 for second unit 1. The pump includes first pump P1 and second pump P2 which are disposed within unit housing UH1 and unit housing UH2, respectively. Unit housing UH1 and unit housing UH2 are formed independently of each other. First suction port 70 is formed in unit housing UH1 and communicated with the suction portion of first pump P1. First high pressure port 66 is formed in unit housing UH1 and communicated with the discharge portion of first pump P1. First high pressure port 66 serves as a first discharge port. Second low pressure port 53 is formed in unit housing UH2 and communicated with the suction portion of second pump P2. Second low pressure port 53 serves as a second suction port. Wheel cylinder-side ports PRR, PFL, PFR, PRL are formed in unit housing UH2, and communicated with the discharge portion of second pump P2 and connected to wheel cylinders 2, 3, 4, 5. Wheel cylinder-side ports PRR, PFL, PFR, PRL serve as a second discharge port. Suction pipe 69 connects first suction port 70 and the port of reservoir tank 51. First reservoir chamber 60 is disposed within unit housing UH1 between first suction port 70 and the suction portion of first pump P1. Second reservoir chamber 50 is disposed within unit housing UH2 between second low pressure port 53 and the suction portion of second pump P2. First reservoir chamber 60 and second reservoir chamber 50 respectively have the volumetric capacity that allows reserve of at least a predetermined amount of the brake fluid which is required for one-time braking at the maximum fluid pressure. Second reservoir chamber 50 is connected with wheel cylinder-side ports PRR, PFL, PFR, PRL through which the pressurized brake fluid in wheel cylinders 2, 3, 4, 5 is returned to second reservoir chamber 50.

With the above construction and arrangement, even when suction pipe 69 is fallen off from reservoir tank 51 and/or first suction port 70, the brake fluid is reserved in first reservoir chamber 60 and second reservoir chamber 50. Therefore, first pump P1 and second pump P2 can suck the brake fluid reserved in first and second reservoir chambers 60 and 50 and supply the fluid pressure to wheel cylinders 2, 3, 4, 5. At a result, during transition to the manual braking, the brake-by-wire control can be maintained to thereby ensure a necessary braking force.

(2) First reservoir chamber 60 and second reservoir chamber 50 are communicated with each other through the pipe. Specifically, first reservoir chamber 60 and second reservoir chamber 50 are communicated with each other through low pressure pipe 65 that connects first low pressure port 61 and second low pressure port 53. With this arrangement, the brake fluid returned from wheel cylinders 2, 3, 4, 5 to second reservoir chamber 50 can be circulated to first reservoir chamber 60. Accordingly, even when suction pipe 69 is fallen off from reservoir tank 51 and/or suction port 70, at least a predetermined amount of the brake fluid which is required for one-time braking at the maximum fluid pressure can be supplied to wheel cylinders 2, 3, 4, 5 by using first pump P1.

(3) First and second reservoir chambers 60 and 50 include first and second backflow preventing sections, respectively, which can prevent a backflow of the brake fluid from first reservoir chamber 60 and second reservoir chamber 50 to first suction port 70 and/or second low pressure port 53 and prevent the brake fluid from leaking to the outside of first and second reservoir chambers 60 and 50. Owing to the backflow preventing sections, even when there occurs fall-off or disconnection of suction pipe 69 and/or low pressure pipe 65, at least a predetermined amount of the brake fluid which is required for one-time braking at the maximum fluid pressure can be reserved within first reservoir chamber 60 and/or second reservoir chamber 50.

(4) First reservoir chamber 60 has first inflow port 64 through which the brake fluid flows into first reservoir chamber 60, and first outflow port 63 through which the brake fluid flows out from first reservoir chamber 60. Second reservoir chamber 50 has second inflow port 55a through which the brake fluid flows into second reservoir chamber 50, and second outflow port 56a through which the brake fluid flows out from second reservoir chamber 50. The first backflow preventing section of first reservoir chamber 60 has a construction in which when unit housing UH1 is mounted to the vehicle, first inflow port 64 is positioned upward of first outflow port 63 in the vertical direction of the vehicle, namely, in the up-and-down direction of the vehicle. Second backflow preventing section of second reservoir chamber 50 has a construction in which when unit housing UH2 is mounted to the vehicle, second inflow port 55a is positioned upward of second outflow port 56a in the vertical direction of the vehicle. Accordingly, it is possible to prevent the brake fluid reserved within first and second reservoir chambers 60 and 50 from leaking out of first and second reservoir chambers 60 and 50.

(5) First suction port 70 and first inflow port 64 are arranged such that when unit housing UH1 is mounted to the vehicle, first suction port 70 is positioned upward of first inflow port 64 in the vertical direction of the vehicle. Second inflow port 55a is arranged such that when unit housing UH2 is mounted to the vehicle, second inflow port 55a is positioned at an upper portion of the space forming portion for providing the above-described volume of second reservoir chamber 50. With this arrangement, it is possible to prevent the brake fluid reserved within first and second reservoir chambers 60 and 50 from leaking outside unit housings UH1 and UH2.

(6) First outflow port 63 is arranged such that when unit housing UH1 is mounted to the vehicle, first outflow port 63 is positioned upward of the suction portion of first pump P1 in the vertical direction of the vehicle. Second outflow port 56a is arranged such that when unit housing UH2 is mounted to the vehicle, second outflow port 56a is positioned upward of the suction portion of second pump P2. With this arrangement, it is possible to surely supply the brake fluid within first and second reservoir chambers 60 and 50 to first and second pumps P1 and P2. Further, even when air bubbles enter into the brake fluid, first and second pumps P1 and P2 can be substantially prevented from sucking the air bubbles and therefore deterioration in discharge performance of first and second pumps P1 and P2 can be suppressed.

(7) First and second reservoir chambers 60 and 50 are formed in unit housings UH1 and UH2. Accordingly, the brake control apparatus of this embodiment can be reduced in size and cost thereof without adding other parts.

(7-1) Brake fluid passages for feeding the brake fluid are formed in unit housings UH1 and UH2, respectively. Each of first and second reservoir chambers 60 and 50 is formed by a part of the brake fluid passage which has an increased diameter. Accordingly, the volumes of first and second reservoir chambers 60 and 50 can be provided simply by increasing the diameters of first and second reservoir chambers 60 and 50 without adding other parts or constructions.

(8) Unit housing UH2 is provided with second high pressure port 67 that is connected with the discharge portion of first pump P1 through first high pressure port 66 of unit housing UH1. Second high pressure port 67 serves as an inflow port. Unit housing UH2 is further provided with check valve 25 that allows a flow of brake fluid into an inside of unit housing UH2 through second high pressure port 67. Check valve 25 is provided between second high pressure port 67 and pressure increasing hydraulic passage 59. With this arrangement, even when the fluid pressure is supplied by second pump P2, the brake fluid can be prevented from flowing toward unit housing UH1 through second high pressure port 67 so that the fluid pressure within wheel cylinders 2, 3, 4, 5 can be certainly retained.

(9) Unit housing UH2 is provided with pressure increasing valves 10-13 and pressure reducing valves 20-23 which increase and reduce the fluid pressure within wheel cylinders 2, 3, 4, 5 by using the brake fluid within second reservoir chamber 50, respectively, as well as second pump P2. Accordingly, the brake control apparatus of this embodiment can be made compact in size.

(10) Unit housing UH2 is provided with pressure increasing valves 10-13 and pressure reducing valves 20-23 which increase and reduce the fluid pressure within wheel cylinders 2, 3, 4, 5 by using the brake fluid within second reservoir chamber 50, respectively, even when first pump P1 or any of suction pipe 69, low pressure pipe 65 and high pressure pipe 68 that connect unit housing UH1 and unit housing UH2 is fallen off. With the provision of pressure increasing valves 10-13 and pressure reducing valves 20-23, the fluid pressure within wheel cylinders 2, 3, 4, 5 can be controlled even in a case where all of pipes 69, 65, 68 are damaged.

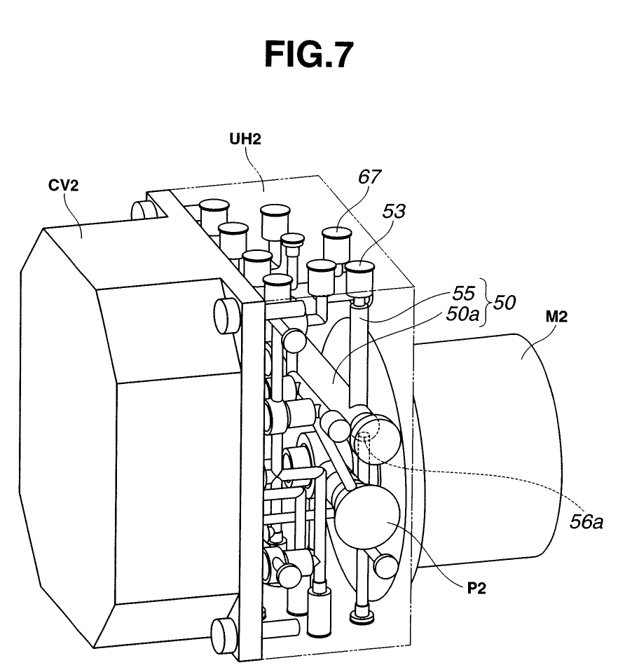

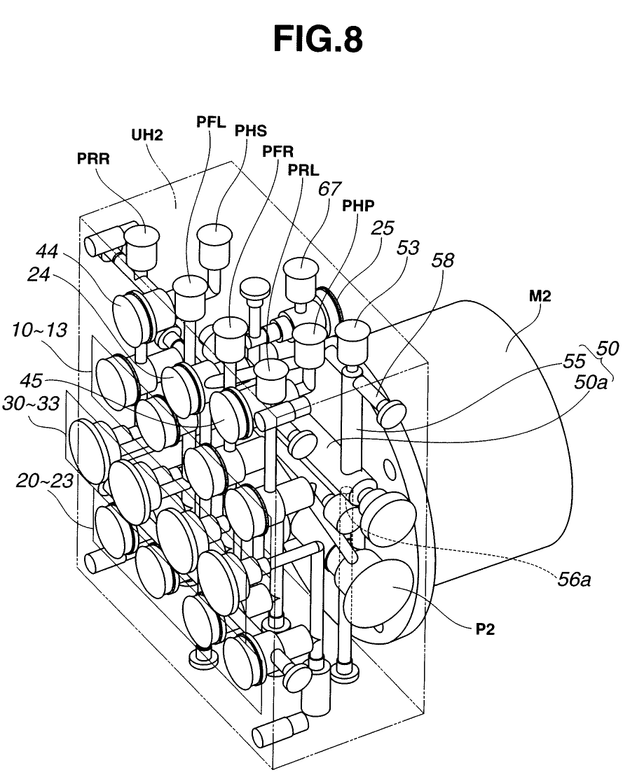

Referring to FIG. 7 and FIG. 8, a second embodiment of the brake control apparatus of the present invention will be explained, which differs from the first embodiment in construction of second unit 1. Like reference numerals and marks denote like parts and therefore detailed explanations therefor are omitted. FIG. 7 is a perspective view of second unit 1 of the second embodiment, in which second cover CV2 is attached to unit housing UH2. FIG. 8 is a perspective view of second unit 1 of the second embodiment, in which second cover CV2 is detached from unit housing UH2.

When viewed from a side of second motor M2 in FIG. 7, second low pressure port 53 is disposed on the left side of second motor M2 and second high pressure port 67 is disposed on the right side of second motor M2. On the other hand, in the first embodiment shown in FIG. 5B, when viewed from a side of second motor M2, second low pressure port 53 is disposed on the right side of second motor M2 and second high pressure port 67 is disposed on the left side of second motor M2.

Further, in the first embodiment shown in FIG. 4, FIG. 5A and FIG. 5B, second reservoir chamber 50 is formed by the large-diameter hydraulic passage that extends in the lateral direction of unit housing UH2. In contrast, in the second embodiment shown in FIG. 7 and FIG. 8, second reservoir chamber 50 is constituted of hydraulic passage 50a and hydraulic passage 55 that connects lateral hydraulic passage 50a and second low pressure port 53. Hydraulic passage 50a extends in the lateral direction of unit housing UH2 and has a diameter slightly smaller than the large-diameter hydraulic passage that serves as second reservoir chamber 50 of the first embodiment. Hydraulic passage 55 is has a diameter which is increased as compared with that in the first embodiment but is smaller than the diameter of lateral hydraulic passage 50a. In this embodiment, the volume of second reservoir chamber 50 is a sum of a volume of hydraulic passage 50a and a volume of hydraulic passage 55.

Thus, the relatively large volume of second reservoir chamber 50 can be provided by combining hydraulic passages 50a and 55 which have the relatively small diameters as compared with the large-diameter hydraulic passage that serves as second reservoir chamber 50 of the first embodiment. This construction of second reservoir chamber 50 may by applied to first reservoir chamber 60 of first unit 8.

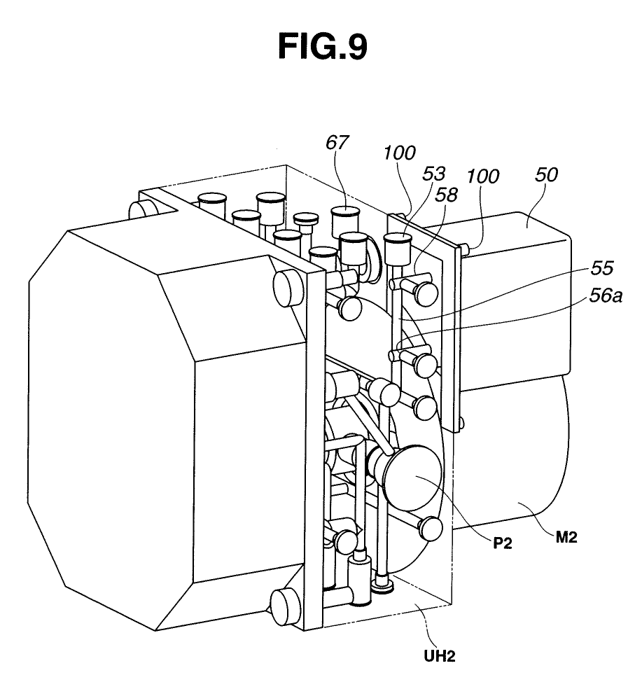

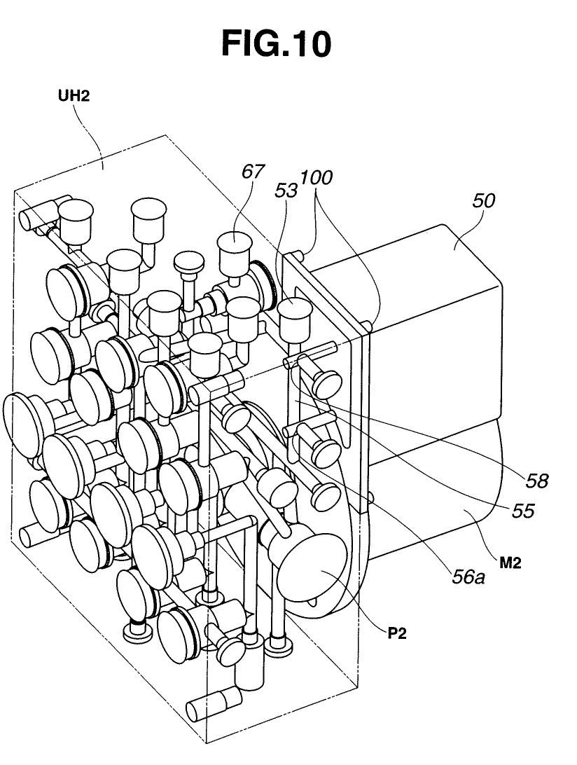

Referring to FIG. 9 and FIG. 10, a third embodiment of the brake control apparatus of the present invention will be explained, which differs from the first embodiment in construction of second unit 1. Like reference numerals and marks denote like parts and therefore detailed explanations therefor are omitted. FIG. 9 is a perspective view of second unit 1 of the third embodiment and shows unit housing UH2 to which second cover CV2 is attached. FIG. 10 is a perspective view of second unit 1 of the third embodiment and shows unit housing UH2 from which second cover CV2 is detached.

When viewed from a side of second motor M2 in FIG. 9, second low pressure port 53 is disposed on the left side of second motor M2 and second high pressure port 67 is disposed on the right side of second motor M2. On the other hand, in the first embodiment shown in FIG. 5B, when viewed from a side of second motor M2, second low pressure port 53 is disposed on the right side of second motor M2 and second high pressure port 67 is disposed on the left side of second motor M2.

Further, in the first embodiment shown in FIG. 4, FIG. 5A and FIG. 5B, second reservoir chamber 50 is formed by the large-diameter hydraulic passage that extends in the lateral direction of unit housing UH2. In contrast, in the third embodiment shown in FIG. 9 and FIG. 10, hydraulic passages extending in the lateral direction of unit housing UH2 have a diameter of an ordinary hydraulic passage which is smaller than the large-diameter hydraulic passage that serves as second reservoir chamber 50 in the first embodiment. Further, in the third embodiment, second reservoir chamber 50 that has a generally four-sided regular prism shape is disposed on the opposite end surface of unit housing UH2 to which second motor M2 is attached. Second reservoir chamber 50 is in the form of a generally four-sided regular prism-shaped box and fixed to the opposite end surface by bolts 100. Similar to the first embodiment, second reservoir chamber 50 of this embodiment has the volume as described above. Second reservoir chamber 50 is connected to second low pressure port 53 via hydraulic passage 55 and two hydraulic passages. Hydraulic passage 55 vertically and straightly extends. The two hydraulic passages extend from hydraulic passage 55 to the opposite end surface of unit housing UH2 and communicate with second reservoir chamber 50.

Second low pressure port 53 is positioned farther apart from a rotation axis of second motor M2 in the lateral direction of unit housing UH2 in order to be out of alignment with an outer diameter of second motor M2. Therefore, hydraulic passage 55 straightly extends in the vertical direction of unit housing UH2, namely, in the vertical direction of the vehicle. With this arrangement, the volume of second reservoir chamber 50 can be sufficiently obtained. Further, it is possible to provide a plurality of hydraulic passages (in this embodiment, the two hydraulic passages) which extend from hydraulic passage 55 and communicate with second reservoir chamber 50. As a result, the hydraulic circuit construction with reduced flow resistance can be provided.

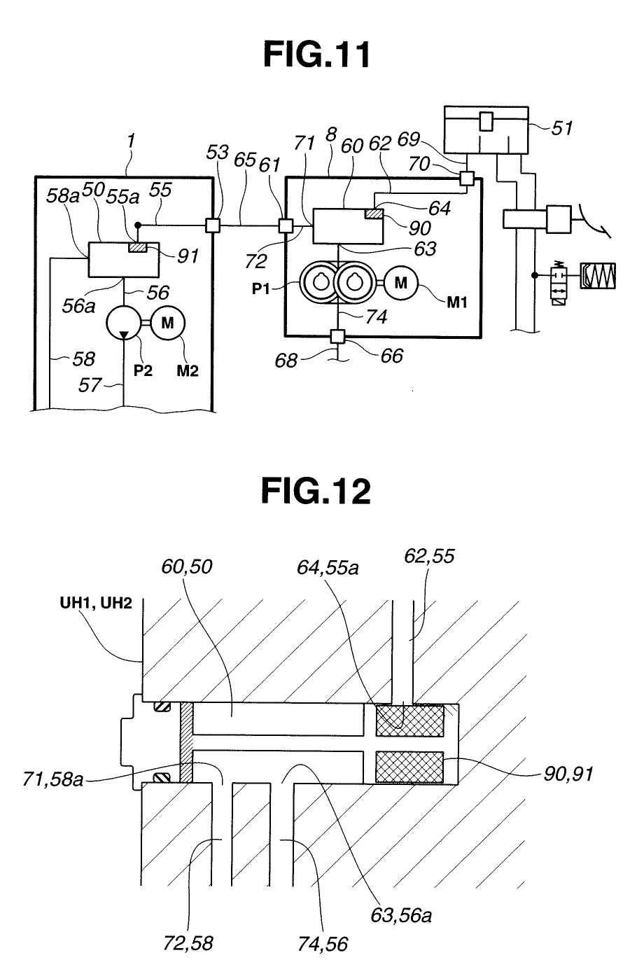

Referring to FIG. 11 and FIG. 12, a fourth embodiment of the brake control apparatus of the present invention will be explained, which differs from the first embodiment in that filters are provided in first and second reservoir chambers 60 and 50. Like reference numerals and marks denote like parts and therefore detailed explanations therefor are omitted. FIG. 11 is a schematic diagram that shows positions of filters 90 and 91 in first and second reservoir chambers 60 and 50. FIG. 12 is a sectional view of respective first and second reservoir chambers 60 and 50, specifically showing filters 90 and 91 in first and second reservoir chambers 60 and 50. For simple illustration, in FIG. 12, first and second reservoir chambers 60 and 50 and filters 90 and 91 are indicated by a single reservoir chamber and a single filter, respectively.

As shown in FIG. 11, filter 90 is disposed within the space of first reservoir chamber 60 so as to be opposed to first inflow port 64. Filter 91 is disposed within the space of second reservoir chamber 50 so as to be opposed to second inflow port 55a.

Specifically, as shown in FIG. 12, first and second reservoir chambers 60 and 50 are formed by the large-diameter hydraulic passages that extend from the side surfaces of unit housings UH1 and UH2, respectively. First and second reservoir chambers 60 and 50 have outer ends that are closed by plugs, respectively. As shown on the right side of FIG. 12, hydraulic passages 62 and 55 extend from above toward an upper side of first and second reservoir chambers 60 and 50 and are open into the circumferential surfaces of first and second reservoir chambers 60 and 50 near inner ends of first and second reservoir chambers 60 and 50. The open ends of hydraulic passages 62 and 55 form first inflow port 64 and second inflow port 55a, respectively. Further, hydraulic passages 74 and 56 extend from below toward a lower side of first and second reservoir chambers 60 and 50 and are open into the circumferential surfaces of first and second reservoir chambers 60 and 50 apart from first and second inflow ports 64 and 55a. Hydraulic passages 74 and 56 are communicated with the suction portions of first and second pumps P1 and P2, respectively. The open ends of hydraulic passages 74 and 56 form first outflow port 63 and second outflow port 56a, respectively. Hydraulic passage 72 and pressure reducing hydraulic passage 58 extend from below toward the lower side of first and second reservoir chambers 60 and 50 and open into the circumferential surfaces of first and second reservoir chambers 60 and 50 apart from first and second outflow ports 63 and 56a. Hydraulic passage 72 is communicated with low pressure pipe 65. The open ends of hydraulic passage 72 and pressure reducing hydraulic passage 58 form first circulation port 71 and second circulation port 58a, respectively.

Filters 90 and 91 are disposed so as to cover first and second inflow ports 64 and 55a from the inside of first and second reservoir chambers 60 and 50, respectively. Filters 90 and 91 are respectively arranged apart from first outflow port 63 and second outflow port 56a which are communicated with the suction portions of first pump P1 and second pump P2. With this arrangement, the brake control apparatus of this embodiment can be prevented from suffering from a pressure drop due to filters 90 and 91 to thereby allow a smooth suction operation of first and second pumps P1 and P2.

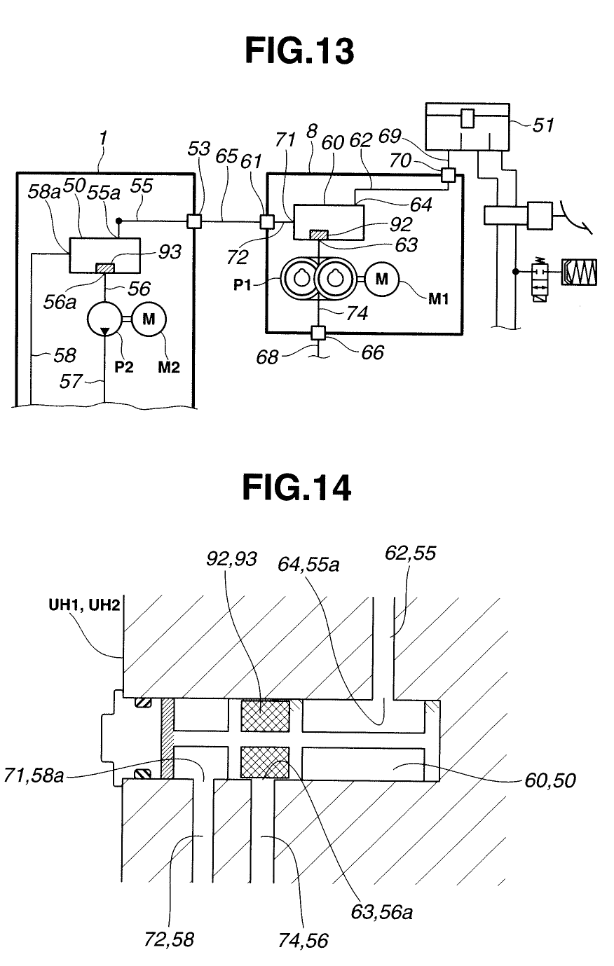

Referring to FIG. 13 and FIG. 14, a fifth embodiment of the brake control apparatus of the present invention will be explained, which differs from the fourth embodiment in arrangement of the filters in first and second reservoir chambers 60 and 50. Like reference numerals and marks denote like parts and therefore detailed explanations therefor are omitted. FIG. 13 is a schematic diagram that shows positions of filters 92 and 93 in first and second reservoir chambers 60 and 50. FIG. 14 is a sectional view of respective first and second reservoir chambers 60 and 50, specifically showing filters 92 and 93 in first and second reservoir chambers 60 and 50. For simple illustration, in FIG. 14, first and second reservoir chambers 60 and 50 and filters 92 and 93 are indicated by a single reservoir chamber and a single filter, respectively.

As shown in FIG. 13, filter 92 is disposed within the space of first reservoir chamber 60 so as to be opposed to first outflow port 63. Filter 93 is disposed within the space of second reservoir chamber 50 so as to be opposed to second outflow port 56a. Specifically, as shown in FIG. 14, filters 92 and 93 are disposed so as to cover first and second outflow ports 63 and 56a from the inside of first and second reservoir chambers 60 and 50, respectively. First and second outflow ports 63 and 56a are communicated with the suction portions of first pump P1 and second pump P2 via hydraulic passages 74 and 56, respectively. With this arrangement of filters 92 and 93, first and second pumps P1 and P2 can be substantially prevented from sucking foreign objects and therefore can be prevented from undergoing failure that will be caused due to sticking of the foreign objects sucked.

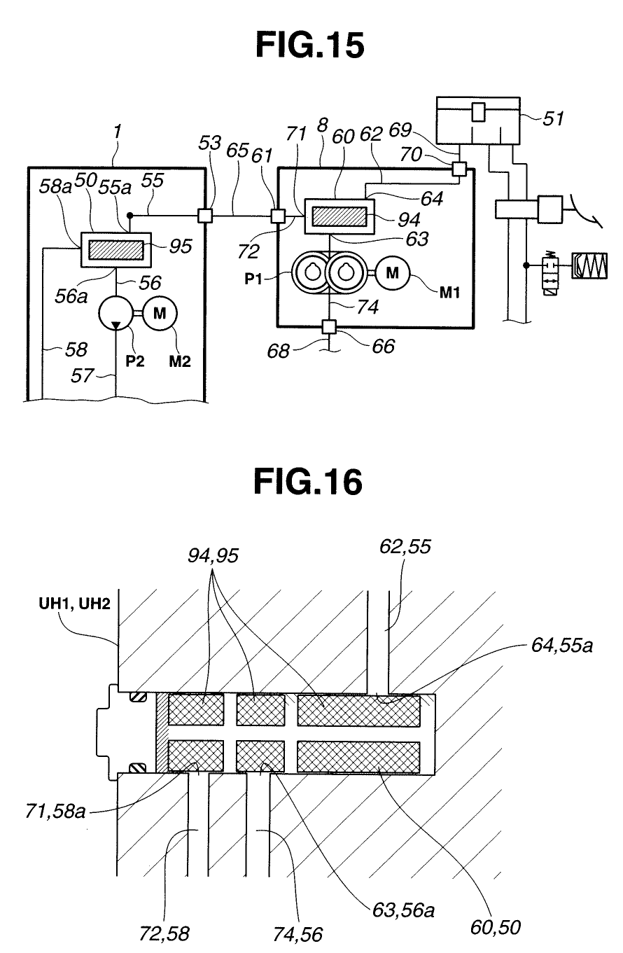

Referring to FIG. 15 and FIG. 16, a sixth embodiment of the brake control apparatus of the present invention will be explained, which differs from the fourth embodiment in arrangement of the filters in first and second reservoir chambers 60 and 50. Like reference numerals and marks denote like parts and therefore detailed explanations therefor are omitted. FIG. 15 is a schematic diagram that shows positions of filters 94 and 95 disposed in first and second reservoir chambers 60 and 50, respectively. FIG. 16 is a sectional view of respective first and second reservoir chambers 60 and 50, specifically showing filters 94 and 95 disposed in first and second reservoir chambers 60 and 50, respectively. For simple illustration, in FIG. 16, first and second reservoir chambers 60 and 50 and filters 94 and 95 are indicated by a single reservoir chamber and a single filter, respectively.

As shown in FIG. 15, filter 94 is disposed within the space of first reservoir chamber 60 so as to be opposed to first inflow port 64, first outflow port 63 and first circulation port 71. Filter 95 is disposed within the space of second reservoir chamber 50 so as to be opposed to second inflow port 55a, second outflow port 56a and second circulation port 58a. Specifically, as shown in FIG. 16, filters 94 and 95 are disposed so as to cover first and second inflow ports 64 and 55a, first and second outflow ports 63 and 56a and first and second circulation ports 71 and 58a from the inside of first and second reservoir chambers 60 and 50, respectively. With this arrangement of filters 94 and 95, first and second reservoir chambers 60 and 50 can be prevented from suffering from entry of foreign objects from the side of reservoir tank 51 through first and second inflow ports 64 and 55a and from the side of wheel cylinders 2, 3, 4, 5 through first and second circulation port 71 and 58a. As a result, it is possible to effectively suppress suction of foreign objects by first and second pumps P1 and P2.

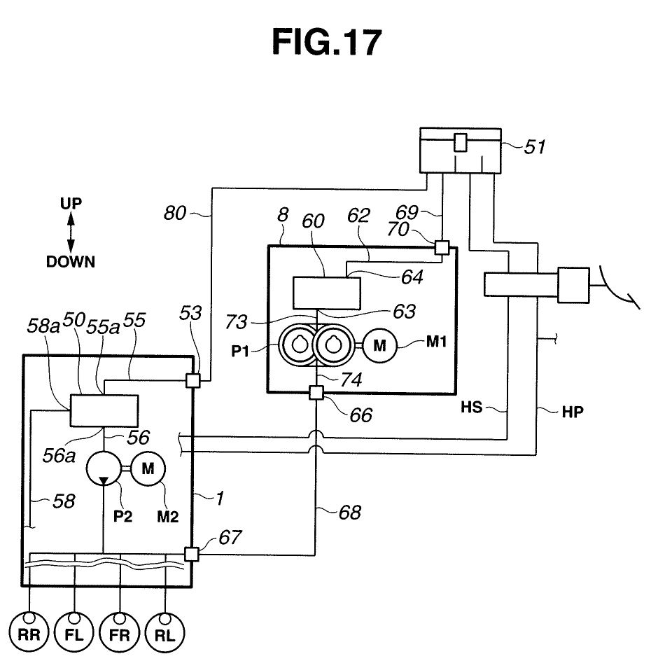

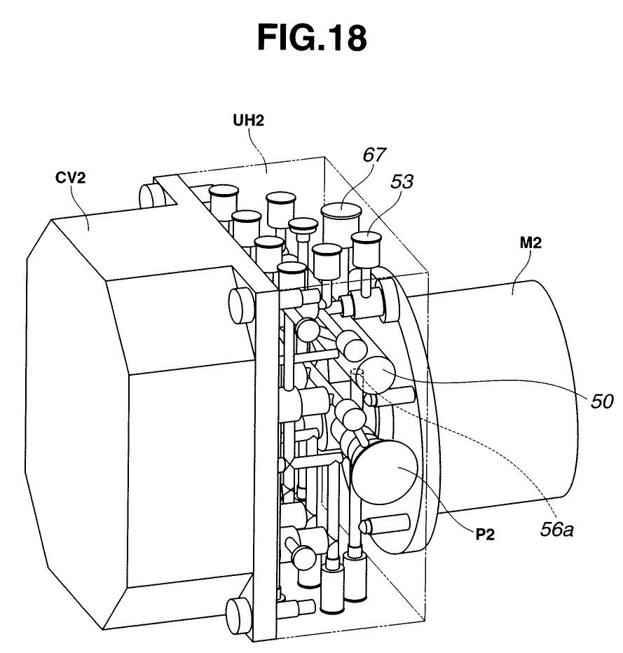

Referring to FIG. 17 and FIG. 18, a seventh embodiment of the brake control apparatus of the present invention will be explained, which differs from the first embodiment in that second unit 1 is directly connected to reservoir tank 51. Like reference numerals and marks denote like parts and therefore detailed explanations therefor are omitted. FIG. 17 is a schematic diagram that shows arrangement of first unit 8 and second unit 1 of the seventh embodiment which are installed into a vehicle, when viewed in a vertical direction of the vehicle.

In the first embodiment, second low pressure port 53 of second unit 1 is connected with first low pressure port 61 via low pressure pipe 65. In contrast, in the seventh embodiment, as shown in FIG. 17, second low pressure port 53 is directly connected with a port of reservoir tank 51 via suction pipe 80. Owing to the direct connection of second low pressure port 53 with reservoir tank 51, low pressure pipe 65, first low pressure port 61 of first unit 8, first circulation port 71 of first reservoir chamber 60, and hydraulic passage 72 that connects first low pressure port 61 and first circulation port 71 are omitted.

Further, reservoir tank 51 is disposed at a highest position. Further, when the position of second outflow port 56a of second reservoir chamber 50 is used as a reference in the vertical direction of the vehicle, second outflow port 56a, second circulation port 58a, second inflow port 55a and second low pressure port 53 are successively arranged upwardly from below in the vertical direction of the vehicle. That is, second circulation port 58a is positioned upward of second outflow port 56a. Second inflow port 55a is positioned upward of second circulation port 58a. Second low pressure port 53 is positioned upward of second inflow port 55a. Similarly, when the position of first outflow port 63 is used as a reference in the vertical direction of the vehicle, first inflow port 64 is positioned upward of first outflow port 63 and first suction port 70 is positioned upward of first inflow port 64.

FIG. 18 is a perspective view of second unit 1 of the seventh embodiment. As shown in FIG. 18, second low pressure port 53 is positioned farther apart from the rotation axis of second motor M2 in the lateral direction of unit housing UH2 as compared to the position of second low pressure port 53 in the first embodiment.

Since second low pressure port 53 and reservoir tank 51 are directly connected with each other, first unit 8 and second unit 1 can be desirably positioned relative to each other in the vertical direction of the vehicle without limitation. Therefore, freedom of layout of first unit 8 and second unit 1 in the vertical direction of the vehicle can be enhanced. Further, the brake control apparatus of this embodiment can be installed to the vehicle without deterioration in bleeding ability and fluid reserving function of first and second reservoir chambers 60 and 50 upon occurrence of disconnection from reservoir tank 51.

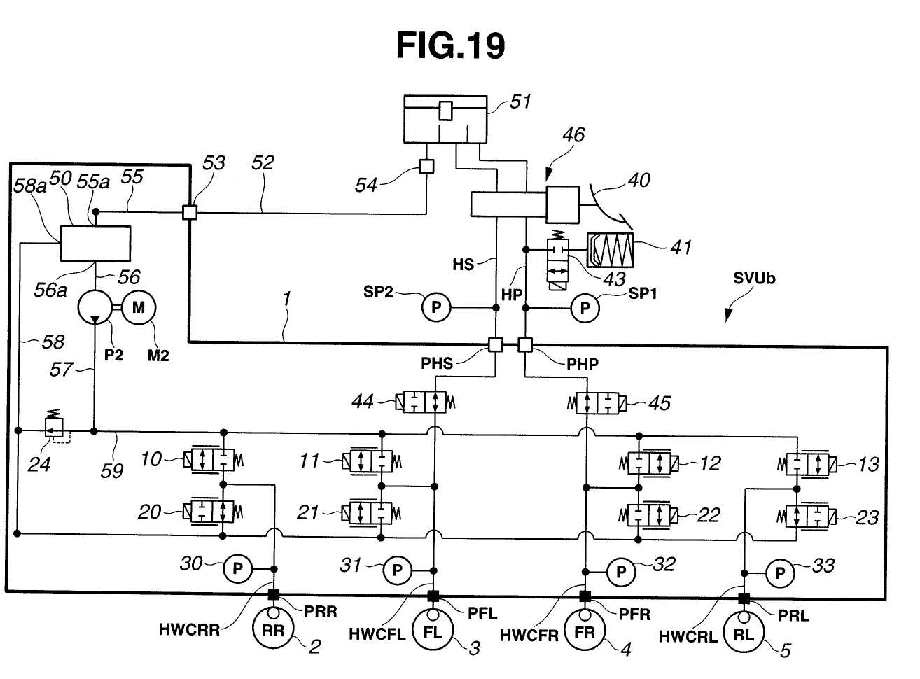

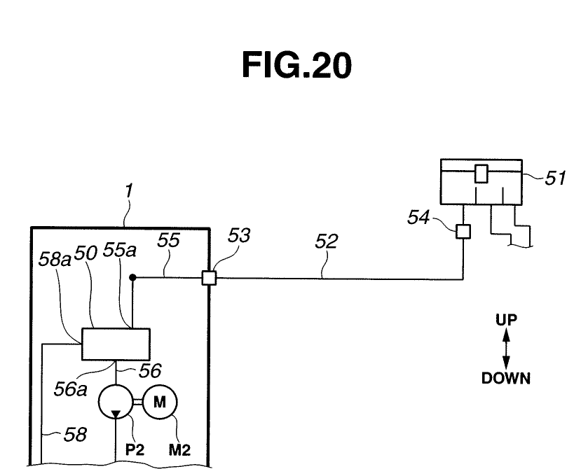

Referring to FIG. 19 and FIG. 20, an eighth embodiment of the brake control apparatus of the present invention will be explained, which differs from the first embodiment in that first unit 8 is omitted and only second unit 1 is used. Like reference numerals and marks denote like parts and therefore detailed explanations therefor are omitted. FIG. 19 is a diagram that shows configuration of a hydraulic circuit in the brake control apparatus of the eighth embodiment.

In the eighth embodiment, second high pressure port 67, check valve 25 and a hydraulic passage that communicates second high pressure port 67 with pressure increasing hydraulic passage 59 which are used in second unit 1 of the first embodiment are omitted. Further, as shown in FIG. 19, suction pipe 52 extends between low pressure port 53 and connection portion 54 of reservoir tank 51. Low pressure port 53 and reservoir tank 51 are connected with each other via suction pipe 52.

FIG. 20 is a schematic diagram that shows arrangement of unit 1 and reservoir tank 51 of the eighth embodiment which are installed into a vehicle, when viewed in a vertical direction of the vehicle. As shown in FIG. 20, when the position of outflow port 56a of reservoir chamber 50 is used as a reference in the vertical direction of the vehicle, outflow port 56a, circulation port 58a and inflow port 55a of reservoir chamber 50 are successively arranged upwardly from below in the vertical direction of the vehicle.

With this arrangement, suction ability of pump P2 can be enhanced. In addition, even when air bubbles enter into reservoir chamber 50 and hydraulic passage 55, pump P2 can be substantially prevented from sucking the air bubbles to thereby suppress deterioration in discharge performance of pump P2. Further, even when there occurs damage to suction pipe 52 or fall-off or disconnection of suction pipe 52 at connection portion 54 or low pressure port 53, the brake fluid in reservoir chamber 50 can be prevented from leaking outside reservoir chamber 50.

The eighth embodiment of the present invention can perform the following functions and effects.

(11) The brake control apparatus of the eighth embodiment includes reservoir tank 51 that reserves brake fluid and pump P2 that is accommodated in unit housing UH2 and sucks the brake fluid reserved in reservoir tank 51 from a suction portion thereof and supplies the pressurized brake fluid from a discharge portion thereof to all of wheel cylinders 2, 3, 4, 5. Unit housing UH2 is provided with low pressure port 53 that is communicated with the suction portion of pump P2 and wheel cylinder-side ports PRR, PFL, PFR, PRL that are communicated with the discharge portion of pump P2. Suction pipe 52 extends between low pressure port 53 and connection portion 54 of reservoir tank 51 and connects low pressure port 53 and a port of reservoir tank 51. Reservoir chamber 50 is disposed within unit housing UH2 between the suction portion of pump P2 and low pressure port 53. Reservoir chamber 50 has the volumetric capacity that allows reserve of at least a predetermined amount of the brake fluid which is required for one-time braking at the maximum fluid pressure.

With the above construction and arrangement, even when suction pipe 52 is fallen off from reservoir tank 51 and/or low pressure port 53, the brake fluid is reserved in reservoir chamber 50 and pump P2 can suck the reserved brake fluid and supply the fluid pressure to wheel cylinders 2, 3, 4, 5. At a result, during transition to the manual braking, the brake-by-wire control can be maintained to thereby ensure a necessary braking force.

(12) Reservoir chamber 50 has a backflow preventing section that can prevent a backflow of the brake fluid from reservoir chamber 50 to low pressure port 53 and leakage to the outside of reservoir chamber 50. Owing to the backflow preventing construction, even when there occurs fall-off or disconnection of suction pipe 52, at least a predetermined amount of the brake fluid which is required for one-time braking at the maximum fluid pressure can be reserved within reservoir chamber 50.

(13) Reservoir chamber 50 has inflow port 55a through which the brake fluid flows into reservoir chamber 50, and outflow port 56a through which the brake fluid flows out from reservoir chamber 50. The backflow preventing section of reservoir chamber 50 has a construction in which when unit housing UH2 for unit 1 is mounted to the vehicle, inflow port 55a is positioned upward of outflow port 56a in the vertical direction of the vehicle. Accordingly, it is possible to prevent the brake fluid reserved within reservoir chamber 50 from leaking out of reservoir chamber 50.

(14) Inflow port 55a is arranged such that when unit housing UH2 for unit 1 is mounted to the vehicle, inflow port 55a is positioned at an upper portion of the space forming portion for providing the above-described volume of reservoir chamber 50 in the vertical direction of the vehicle. With this arrangement, it is possible to prevent the brake fluid reserved within reservoir chamber 50 from leaking outside unit housing UH2.

(15) Outflow port 56a is arranged such that when unit housing UH2 for unit 1 is mounted to the vehicle, outflow port 56a is positioned upward of the suction portion of pump P2. With this arrangement, it is possible to surely supply the brake fluid within reservoir chamber 50 to pump P2. Further, even when air bubbles enter into the brake fluid, pump P2 can be substantially prevented from sucking the air bubbles and therefore deterioration in discharge performance of pump P2 can be suppressed.

(16) Reservoir chamber 50 is formed in unit housing UH2 for unit 1. Accordingly, the brake control apparatus of the eighth embodiment can be reduced in size and cost thereof without adding other parts.

(17) Unit housing UH2 for unit 1 is provided with groups of valves which increase and reduce the fluid pressure within wheel cylinders 2, 3, 4, 5 by using the brake fluid within reservoir chamber 50 in cooperation with pump P2. Accordingly, the brake control apparatus of this embodiment can be made compact in size.

(18) Unit housing UH2 for unit 1 is provided with groups of valves which increase and reduce the fluid pressure within wheel cylinders 2, 3, 4, 5 by using the brake fluid within reservoir chamber 50 in cooperation with pump P2, even when suction pipe 52 is fallen off. With the provision of the groups of valves, the fluid pressure within wheel cylinders 2, 3, 4, 5 can be controlled even in a case where suction pipe 52 is damaged.

(19) Brake fluid passage for feeding the brake fluid is formed in unit housing UH2 for unit 1. Reservoir chamber 50 is formed by a part of the brake fluid passage which has an increased diameter. Accordingly, the volume of reservoir chamber 50 can be provided simply by increasing a diameter of reservoir chamber 50 without adding other parts or construction.

This application is based on a prior Japanese Patent Application No. 2007-070056 filed on Mar. 19, 2007. The entire contents of the Japanese Patent Application No. 2007-070056 is hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A brake control apparatus for a vehicle including wheels with wheel cylinders, the brake control apparatus comprising:
a reservoir tank that reserves a brake fluid;
a housing;
a pump disposed within the housing, the pump sucking the brake fluid in the reservoir tank and discharging the brake fluid under pressure to the wheel cylinders,
a suction port that is formed in the housing and communicated with a suction portion of the pump;
a discharge port that is formed in the housing and communicates a discharge portion of the pump with the wheel cylinders;
a suction pipe that connects the suction port and a port of the reservoir tank; and
a reservoir chamber that is disposed within the housing between the suction portion of the pump and the suction port, the reservoir chamber having a volume capable of reserving at least a predetermined amount of the brake fluid which is required for one-time braking at a maximum fluid pressure.

2. The brake control apparatus as claimed in claim 1, wherein the reservoir chamber comprises a backflow preventing section that prevents a backflow of the brake fluid from the reservoir chamber to the suction port and leakage of the brake fluid to an outside of the reservoir chamber.

3. The brake control apparatus as claimed in claim 2, wherein the reservoir chamber comprises an inflow port through which the brake fluid flows into the reservoir chamber, and an outflow port through which the brake fluid flows out from the reservoir chamber, and the backflow preventing section has a construction in which when the housing is mounted to the vehicle, the inflow port of the reservoir chamber is positioned upward of the outflow port of the reservoir chamber in a vertical direction of the vehicle.

4. The brake control apparatus as claimed in claim 3, wherein the suction port and the reservoir tank are arranged such that when the housing is mounted to the vehicle, the suction port is positioned upward of the inflow port of the reservoir chamber and the reservoir tank is positioned upward of the suction port.

5. The brake control apparatus as claimed in claim 1, wherein the outflow port of the reservoir chamber is arranged such that when the housing is mounted to the vehicle, the outflow port of the reservoir chamber is positioned upward of the suction portion of the pump.

6. The brake control apparatus as claimed in claim 1, wherein the reservoir chamber is formed in the housing.

7. The brake control apparatus as claimed in claim 1, wherein the reservoir chamber comprises a second inflow port open into the reservoir chamber, the second inflow port allowing the brake fluid that is supplied from the pump into the wheel cylinders to be returned to the reservoir chamber.

8. The brake control apparatus as claimed in claim 3, further comprising a filter that is disposed in the inflow port and the outflow port of the reservoir chamber.

9. The brake control apparatus as claimed in claim 6, wherein the suction port is positioned upward of the inflow port of the reservoir chamber, the reservoir tank is positioned upward of the suction port, and the outflow port of the reservoir chamber is positioned upward of the suction portion of the pump.

10. The brake control apparatus as claimed in claim 6, wherein the housing is formed with a brake fluid passage for feeding the brake fluid, and the reservoir chamber is formed by a part of the brake fluid passage which has an increased diameter.

11. A brake control apparatus for a vehicle including wheels with wheel cylinders, the brake control apparatus comprising:
a reservoir tank that reserves a brake fluid;
a first pump and a second pump which suck the brake fluid in the reservoir tank and discharge the brake fluid under pressure to the wheel cylinders, respectively,
a first housing that accommodates the first pump, the first housing being formed with a first suction port that is communicated with a suction portion of the first pump, and a first discharge port that is communicated with a discharge portion of the first pump,
a second housing that is formed independently of the first housing, the second housing accommodating the second pump, the second housing being formed with a second suction port that is communicated with a suction portion of the second pump, and a second discharge port that is communicated with a discharge portion of the second pump and connected to the wheel cylinders,
a suction pipe that connects the first suction port and a port of the reservoir tank;
a first reservoir chamber disposed within the first housing between the suction portion of the first pump and the first suction port; and
a second reservoir chamber disposed within the second housing between the suction portion of the second pump and the second suction port,
wherein the first and second reservoir chambers each have a volume capable of reserving at least a predetermined amount of the brake fluid which is required for one-time braking at a maximum fluid pressure, and the second reservoir chamber is connected with the second discharge port through which the brake fluid in the wheel cylinders is returned to the second reservoir chamber.

12. The brake control apparatus as claimed in claim 11, wherein the first and second reservoir chambers comprise backflow preventing sections that prevent a backflow of the brake fluid from the first and second reservoir chambers to the first and second suction ports and leakage of the brake fluid to an outside of the first and second reservoir chambers, respectively.

13. The brake control apparatus as claimed in claim 11, wherein the first and second reservoir chambers comprise inflow ports through which the brake fluid flows into the first and second reservoir chambers, outflow ports through which the brake fluid flows out from the first and second reservoir chambers, and backflow preventing sections that prevent a backflow of the brake fluid from the first and second reservoir chambers to the first and second suction ports and leakage of the brake fluid to an outside of the first and second reservoir chambers, respectively, and the backflow preventing sections have a construction in which when the first and second housings are mounted to the vehicle, the inflow ports of the first and second reservoir chambers are positioned upward of the outflow ports of the first and second reservoir chambers in a vertical direction of the vehicle, respectively.

14. The brake control apparatus as claimed in claim 13, wherein the first reservoir chamber comprises a second inflow port that is open into the first reservoir chamber and permits the brake fluid in the wheel cylinders to be returned to the first reservoir chamber, and when the first housing is mounted to the vehicle, the first suction port is positioned upward of the second inflow port of the first reservoir chamber in a vertical direction of the vehicle, the reservoir tank is positioned upward of the first suction port in the vertical direction of the vehicle, and the second inflow port is positioned at an upper end of a space forming portion for providing the volume of the first reservoir chamber, in the vertical direction of the vehicle.

15. The brake control apparatus as claimed in claim 11, wherein when the first and second housings are mounted to the vehicle, the outflow ports of the first and second reservoir chambers are positioned upward of the suction portions of the first and second pumps, respectively.

16. The brake control apparatus as claimed in claim 11, wherein the first and second reservoir chambers are formed in the first and second housings, respectively.

17. The brake control apparatus as claimed in claim 11, wherein the second housing is provided with groups of valves which increase and reduce a fluid pressure within the wheel cylinders by using the brake fluid reserved in the second reservoir chamber in cooperation with the second pump.

18. The brake control apparatus as claimed in claim 17, wherein the second housing is provided with an inflow port that is connected with the discharge portion of the first pump, and a check valve that allows a flow of brake fluid into an inside of the second housing through the inflow port of the second housing.

19. The brake control apparatus as claimed in claim 17, wherein the second housing is provided with groups of valves which increase and reduce a fluid pressure within the wheel cylinders by using the brake fluid reserved in the second reservoir chamber in cooperation with the second pump in a case where the first pump or the suction pipe is fallen off.

20. A brake control apparatus for a vehicle including wheels with wheel cylinders, the brake control apparatus comprising:
a reservoir tank that reserves a brake fluid;
a housing;
a pump disposed within the housing, the pump sucking the brake fluid in the reservoir tank and discharging the brake fluid under pressure to the wheel cylinders,
a suction port that is formed in the housing and communicated with a suction portion of the pump;
a discharge port that is formed in the housing and communicates a discharge portion of the pump with the wheel cylinders;
a suction pipe that connects the suction port and a port of the reservoir tank; and
a reservoir chamber that is disposed within the housing between the suction portion of the pump and the suction port,
the reservoir chamber having a volume capable of reserving at least a predetermined amount of the brake fluid which is required for one-time braking at a maximum fluid pressure,
wherein the reservoir chamber comprises a backflow preventing section that prevents a backflow of the brake fluid from the reservoir chamber to the suction port and leakage of the brake fluid to an outside of the reservoir chamber,
wherein the reservoir chamber is formed in the housing, and
wherein the housing is formed with a brake fluid passage for feeding the brake fluid, and the reservoir chamber is formed by a part of the brake fluid passage which has an increased diameter.
